(19) United States
(12) Patent Application Publication
(10) Pub. No.: US 2015/0379064 A1
(43) Pub. Date: Dec. 31, 2015

(54) DEPENDENCY MANAGEMENT DURING MODEL COMPILATION OF STATISTICAL MODELS

(71) Applicant: LinkedIn Corporation, Mountain View, CA (US)

(72) Inventors: Doris S. Xin, Mountain View, CA (US); Jonathan D. Traupman, Oakland, CA (US); Xiangrui Meng, Berkeley, CA (US); Paul T. Ogilvie, Palo Alto, CA (US)

(21) Appl. No.: 14/314,839

(22) Filed: Jun. 25, 2014

(51) Int. Cl. G06F 17/30; G06F 17/18

(52) U.S. Cl. CPC G06F 17/30371; G06F 17/18

(57) ABSTRACT

The disclosed embodiments provide a method and system for processing data. During operation, the system obtains a dependency graph associated with feature selection in a statistical model, wherein nodes in the dependency graph include one or more feature sources, one or more transformers, and an assembler. Next, the system uses the dependency graph to derive an evaluation order associated with the nodes. The system then compiles a set of configurations for the statistical model according to the evaluation order.

### RELATED APPLICATION

The subject matter of this application is related to the subject matter in a co-pending non-provisional application by inventors Jonathan D. Traupman, Deepak Agarwal, Liang Zhang, Bo Long, and Frank E. Astier, entitled “Systems and Methods for Content Response Prediction,” having Ser. No. 13/906,874, and filing date 31 May 2013 (Attorney Docket No. 3080.117US1).

The subject matter of this application is also related to the subject matter in a co-pending non-provisional application by inventors Doris Xin, Jonathan Traupman, Xiangrui Meng and Paul Ogilvie, entitled “Model Compilation for Feature Selection in Statistical Models,” having serial number TO BE ASSIGNED, and filing date TO BE ASSIGNED (Attorney Docket No. LI-P0279.LNK.US).

### BACKGROUND

1. Field

The disclosed embodiments relate to data analysis techniques. More specifically, the disclosed embodiments relate to techniques for performing dependency management during model compilation of statistical models, in which configurations for the statistical models are compiled using compilation parameters associated with feature selection in the statistical models.

2. Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of statistical models. The discovered information may then be used to guide decisions and/or perform actions related to the data. For example, the output of a statistical model may be used to guide marketing decisions, assess risk, detect fraud, predict behavior, and/or customize or optimize use of an application or website.

However, significant time, effort, and overhead may be spent on feature selection during creation and training of statistical models for analytics.

For example, a data set for a statistical model may have thousands to millions of features, including features that are created from combinations of other features, while only a fraction of the features and/or combinations may be relevant and/or important to the statistical model. At the same time, training and/or execution of statistical models with large numbers of features typically require more memory, computational resources, and time than those of statistical models with smaller numbers of features. Excessively complex statistical models that utilize too many features may additionally be at risk for overfitting.

Consequently, creation and use of statistical models in analytics may be facilitated by mechanisms for efficiently and effectively performing feature selection for the statistical models.

### BRIEF DESCRIPTION OF THE FIGURES

FIG. 1 shows a schematic of a system in accordance with the disclosed embodiments.

FIG. 2 shows a data-processing system in accordance with the disclosed embodiments.

FIG. 3 shows an exemplary dependency graph and data flow associated with feature selection in a statistical model in accordance with the disclosed embodiments.

FIG. 4 shows a flowchart illustrating the processing of data in accordance with the disclosed embodiments.

FIG. 5 shows a flowchart illustrating the processing of data in accordance with the disclosed embodiments.

FIG. 6 shows a flowchart illustrating the process of compiling a set of configurations for a statistical model according to an evaluation order in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

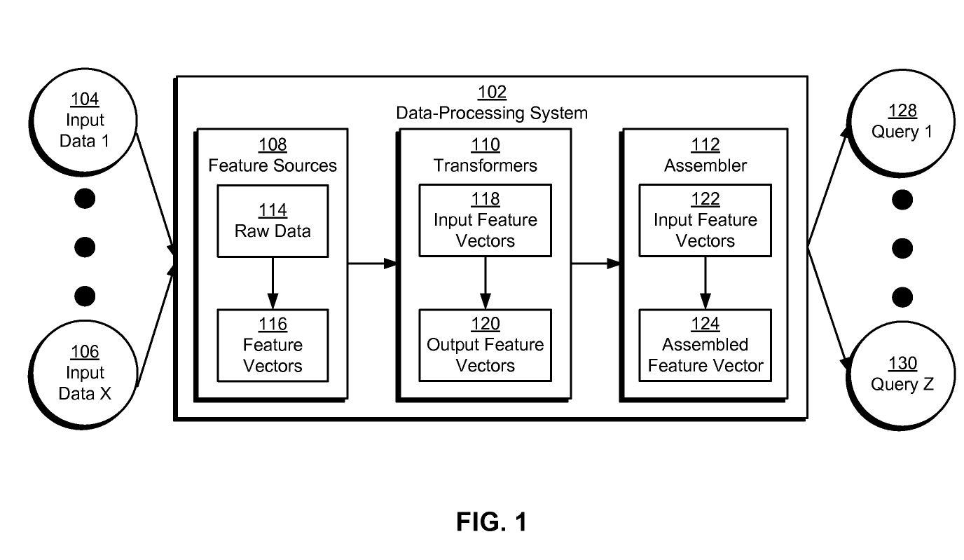

The disclosed embodiments provide a method and system for processing data. As shown in FIG. 1, the system may correspond to a data-processing system 102 that analyzes one or more sets of input data (e.g., input data 1 104, input data x 106) to discover relationships, patterns, and/or trends in the input data; gain insights from the input data; and/or guide decisions and/or actions related to the input data.

The results from such data analysis may be provided in responses to queries (e.g., query 1 128, query z 130) of data-processing system 102. For example, data-processing system 102 may create and train one or more statistical models for analyzing input data related to users, organizations, applications, websites, content, and/or other categories. Data-processing system 102 may then use the statistical models to generate output scores that may be queried and used to improve revenue, interaction with the users and/or organizations, use of the applications and/or content, and/or other metrics associated with the input data.

In addition, the functionality of data-processing system 102 may be provided by one or more feature sources 108, one or more transformers 110, and an assembler 112. Feature sources 108 may process raw data 114 from external sources of input data (e.g., input data 1 104, input data x 106) into standardized feature vectors 116. For example, data-processing system 102 may include a feature source that uses text-mining techniques to convert freeform content items such as web pages, advertisements, articles, and/or documents into a structured, reusable format, such as a set of augmented keywords from each content item.

Transformers 110 may transform input feature vectors 118 from feature sources 108 and/or other transformers into output feature vectors 120 that may be used by other transformers and/or assembler 112. For example, transformers 110 may include a subset transformer that selects a subset of a set of input features from an input feature vector, such as features that are most relevant and/or important to a given statistical model. Transformers 110 may also include a bucketizing transformer that transforms a numeric input feature (e.g., age, income, revenue, temperature) into a set of binary numeric features (e.g., age ranges, income ranges, revenue ranges, temperature ranges). Transformers 110 may further include a disjunction transformer that performs a logical disjunction of one or more sets of binary input features, such as grouping related binary features (e.g., job industries, foods) into a single binary feature (e.g., industry group, food group) that is true when any of the binary features in the group are true. Transformers 110 may additionally include an interaction transformer that calculates an outer product of a first set of input features and a second set of input features, thus identifying positive and/or negative correlations between the first and second sets of input features. Finally, transformers 110 may include a summation transformer that sums a set of values for an numeric input feature over a range, such as a number of clicks or revenue over a pre-specified sliding window (e.g., one week, one month, one year).

Assembler 112 may take input feature vectors 122 from feature sources 108 and/or transformers 110 and create an assembled feature vector 124 from input feature vectors 122. Assembled feature vector 124 may include blocks of features from various feature sources 108 and/or transformers 110 associated with assembler 112. Assembled feature vector 124 may then be provided to a statistical model for training and/or execution purposes. Feature sources, transformers, and assemblers for data analysis are described in a co-pending non-provisional application by inventors Jonathan D. Traupman, Deepak Agarwal, Liang Zhang, Bo Long, and Frank E. Astier, entitled “Systems and Methods for Content Response Prediction,” having Ser. No. 13/906,874 and filing date 31 May 2013 (Attorney Docket No. 3080.117US1), which is incorporated herein by reference.

As discussed in the above-referenced application, feature sources 108, transformers 110, assembler 112, and/or other components of data-processing system 102 may be configured for use with a statistical model using configuration files. For example, the configuration files and/or executable versions of the components may describe sources of input data and/or features to the components; encoding rules for encoding raw data 114 into feature vectors 116 at feature sources 108; transformation rules for transforming data in input feature vectors 118 into output feature vectors 120 at transformers 110; and/or assembly rules for generating assembled feature vectors 124 from input feature vectors 122 at assembler 112.

However, such configuration files may require the manual declaration of specific features inputted to and/or outputted from the components, which may cause writing of the configuration files to be tedious and/or error-prone. For example, a configuration file for a subset transformer may list thousands or tens of thousands of features to be included in the subset transformer's output feature vector. In addition, the features may be identified using indexes to the features' locations in the input feature vector of the subset transformer instead of the features' names, thus increasing the likelihood that an error will be introduced into the configuration file by a human writer (e.g., by entering the wrong numeric index for a feature).

In one or more embodiments, creation and use of statistical models in data-processing system 102 are facilitated by mechanisms for performing model compilation for feature selection in the statistical models and/or dependency management during model compilation. As discussed in further detail below, model compilation may allow features used and/or transformed by the components to be described in an abstract, high-level way, thus improving the efficiency and accuracy of feature selection and model creation. In addition, dependency management during model compilation may further streamline the compilation process (e.g., by creating parallel processes for running compilers whenever allowed by the dependency structures associated with the statistical models) and/or reduce overhead associated with detecting and managing errors in the configurations.

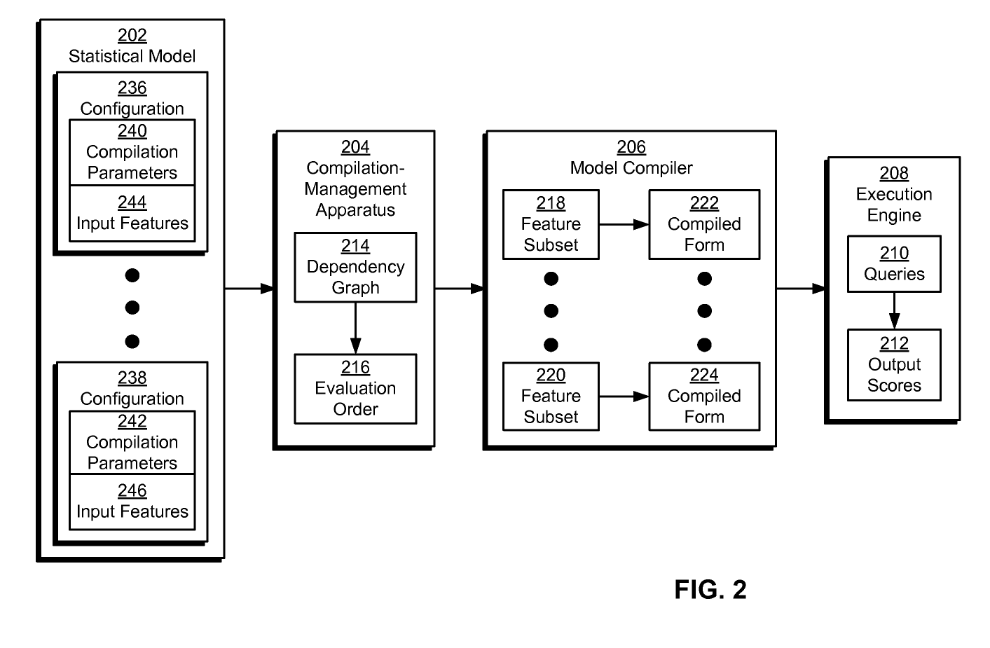

FIG. 2 shows a data-processing system, such as data-processing system 102 of FIG. 1, in accordance with the disclosed embodiments. As shown in FIG. 2, features used by feature sources (e.g., feature sources 108 of FIG. 1), transformers (e.g., transformers 110 of FIG. 1), an assembler (e.g., assembler 112 of FIG. 1), and/or other components associated with a statistical model 202 may be described using compilation parameters 240-242 in the corresponding configurations 236-238 (e.g., configuration files) instead of explicitly declared using lists of feature names and/or indexes.

Compilation parameters 240-242 may represent a high-level and/or abstract description of features to be used and/or transformed by the components (e.g., feature sources, transformer, assemblers, etc.) of statistical model 202. A model compiler 206 may apply compilation parameters 240-242 from each configuration 236-238 to a set of input features 244-246 specified in the configuration to obtain an explicit feature subset 218-220 for the configuration. For example, model compiler 206 may use compilation parameters 240-242 in configurations 236-238 to filter, transform, and/or otherwise process input features 244-246 from raw data or input feature vectors and obtain feature subsets 218-220 to be included in output feature vectors and/or an assembled feature vector for statistical model 202.

Model compiler 206 may then compile configurations 236-238 by including feature subsets 218-220 in compiled forms 222-224 of configurations 236-238. Because high-level descriptions of features are automatically transformed into low-level details of specific selected features during model compilation, model compiler 206 may reduce time, difficulty, and user error associated with manually creating (e.g., writing) configurations 236-238.

As mentioned above and/or in the above-referenced application, configurations 236-238 may use a domain-specific language to describe feature sources, transformers, assemblers, and/or other components associated with statistical model 202. In addition, different types of transformers may be used in feature selection and/or extraction for statistical model 202. As a result, configurations (e.g., configurations 236-238) for the transformers may differ in the number and types of compilation parameters 240-242, and compilation of configurations for different types of transformers may be carried out in different ways.

For example, a subset transformer may have the following uncompiled configuration, as represented by a JavaScript Object Notation (JSON) object:

{

“name”: “subset_transformer”,
“class”: “com.linkedin.laser.common.transformer.SubsetTransformer”,
“parameters”: {

“input”: “some_other_producer”,
“features”: {

“names”: [ “geo_country” ],
“name_regexes”: [“industry:.*”, “company:.*”],
“indices”: [ 235, 763, 1845, 3498 ]

}

},
“compilation_configs”: [{

“compiler_class”:

“com.linkedin.laser.common.compiler.SubsetCompiler”,

“is_compiled”: false,
“compilation_dependencies”: [“some_other_producer”],
“compiler_name”: “compiler1”
“dependencies”: [ ],
“compiler_parameters”: {

“features”: {

“name_regexes”: [ “skill:.*”, “title:.*” ]

}
“min_support”: 10000,
“min_support_fraction”: 0.02,
“max_features”: 1000,
“min_mutual_information”: 0.75,
“comparator_class”:

“com.linkedin.laser.common.compiler.SubsetCompiler$SupportComparator”

}

}

}
The configuration may then be compiled into the following JSON object:
{

“name”: “subset_transformer”,
“class”: “com.linkedin.laser.transformer.SubsetTransformer”, “parameters”: {

“input”: “some_other_producer”,
“features”: {

“names”: [ “geo_country”, “ industry:ind1”, “ industry:ind2”,

“company:comp1”, “company:comp3”, “skill:s1”, “title:t1” ],

“name_regexes”: [“industry:.*”, “company:.*”, “skill:.*”, “title:.*”],
“indices”: [ 235, 763, 1845, 3498, 9743, 102402, 132908 ]

}

}

}

The subset transformer configuration may accept “pre-written” (e.g., declared) lists of strings or patterns of feature names (e.g., “parameters.features.names,” “parameters.features.name_regexes”), as well as numeric identifiers representing feature indexes (e.g., “parameters leatures.indices”). The pre-written parameters describe features that must be included regardless of compilation parameters in the configuration.

On the other hand, compilation parameters (e.g., compilation parameters 240-242) under “compilation_configs.compiler_parameters” may specify how features for the subset transformer are to be compiled. For example, the compilation parameters may include feature names and/or indexes of candidates for inclusion in the subset transformer. If the compilation parameters lack both names and indexes, all features in the input may be considered eligible candidates. In the compiled object, the feature names (e.g., “parameters.features.names”) and feature indexes (e.g., “parameters.features.indices”) may be one-to-one.

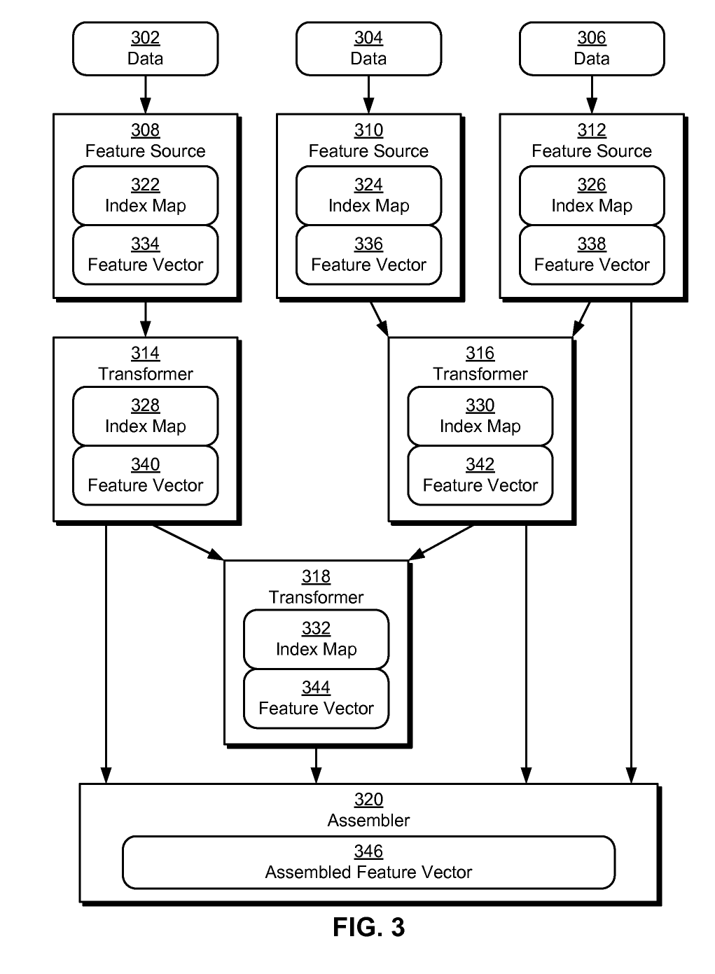

To provide both feature names and indexes in the compiled configuration, model compiler 206 may fill in feature names and/or feature indexes for features selected for inclusion in the subset transformer using an index map associated with a set of input features (e.g., “parameters.input”) for the configuration. As a result, a writer of the configuration may specify features to be considered for inclusion and/or included in the configuration using descriptive feature names and/or regular expressions matching the feature names instead of numeric, non-descriptive feature indexes. Use of index maps in compiling configurations for statistical models is discussed in further detail below with respect to FIG. 3.

Compilation parameters in the JSON object may also include a minimum support (e.g., “min_support”), or the minimum number of feature occurrences in training data for statistical model 202 for a feature to be considered for inclusion. Similarly, the compilation parameters may specify a minimum support fraction (e.g., “min_support_fraction”), or the minimum fraction of training examples that must contain a given feature for the feature to be considered for inclusion. If both a minimum support and minimum support fraction are specified, the higher value may take precedence.

The compilation parameters may also specify a minimum mutual information (e.g., “min_mutual_information”) score between a feature and the response of statistical model 202. To determine the mutual information score for a given feature, statistical model 202 may be trained with only that feature to determine the effect of the feature in isolation on statistical model 202. Features with mutual information scores that exceed the minimum mutual information may then be considered for inclusion in the subset transformer.

Finally, the compilation parameters may indicate a maximum number of features (e.g., “max features”) to include in the subset transformer, as well as a comparator (e.g., “comparator class”) associated with sorting the input features. Any pre-written (e.g., explicitly specified) features in the configuration may be kept in the compiled configuration and count toward the total, maximum number of features. If the number of pre-written features exceeds the maximum number of features, all may be kept, but no new features are added during compilation. If the pre-written features have not reached the maximum number, the comparator may be used to sort the compiled features, and the compiled features may be added to the compiled configuration (e.g., under “parameters.features.names” and “parameters.features.indices”) according to the sorting up to the maximum number of features.

In another example, a bucketizing transformer may have the follow uncompiled “source” configuration in JSON:

{

“name”: “bucketizing_transformer”,
“class”: “com.linkedin.laser.common.transformer.BucketizingTransformer”,
“parameters”: {

“input”: “some_other_producer”,
},

“compilation_configs”: [ {

“compiler_class”:

“com.linkedin.laser.common.compiler.BucketizerHistogramCompiler”,

“is_compiled”: false,
“compiler_parameters”: {

“inputIndex”: 5,
“numBuckets”: 3

}

},
{

“compiler_class”:

“com.linkedin.laser.common.compiler.BucketizerCompiler”,

“is_compiled”: false,
“compiler_parameters”: {

“groups”: [

{

“inputFeatureName”: “age”,
“buckets”: [

{

“start”: 0.0,
“end”: 18.0,
“name”: “minor”

},
{

“start”: 18.0,
“end”: 25.0

},
{

“start”: 25.0

}

]

}

]

}

]

}
The configuration may then be compiled into the following form:
{

“name”: “bucketizing_transformer”,
“class”: “com.linkedin.laser.transformer.BucketizingTransformer”,
“parameters”: {

“input”: “some_other_producer”,
“groups”: [

{

“inputFeatureName”: “age”,
“inputIndex”: 3,
“buckets”: [

{ “start”: 0.0, “end”: 18.0, “name”: “minor”, “index”: 0 }
{ “start”: 18.0, “end”: 25.0, “name”: “age_18.0-25.0”, “index”:

1},

{ “start”: 25.0, “name”: “age_25.0-”, “index”: 2 }

]

```
  },
  {
```

“inputFeatureName”: “num_connections”,
“inputIndex”: 5,
“buckets”: [

{ “start”: 0, “end”: 50, “name”: “num_connections_0-50”,

“index”: 3 },

{ “start”: 51, “end”: 500, “name”: “num_connections_51-500”,

“index”: 4 },

{ “start”: 501, “name”: “num_connections_501-”, “index”: 5 }

]

}

]

}

}

In the above example, the configuration invokes multiple compilers to compile the bucketizing transformer. One compiler (e.g., “BucketizerCompiler”) assigns feature indexes and names to “buckets” (e.g., binary numeric features) defined by the writer of the configuration. If pre-written parameters are included, the index assignment process skips any pre-assigned indexes. If the pre-written parameters contain duplicate indexes, an error is thrown during compilation and/or instantiation (e.g., if no compilation is required) of the bucketizing transformer. Within each bucket, all source parameters are optional. An unspecified “start” or “end” to a bucket may default to negative infinity or positive infinity, respectively. If no “name” is specified, model compiler 206 may synthesize a name from the input feature specified by “inputFeatureName” and/or “inputIndex” and the range from “start” to “end.”

The numeric input feature used to create a group of binary numeric features may be specified either numerically (e.g., using “inputIndex”) or by name (e.g., using “inputFeatureName”). Because each group of transformed features must be associated with a single feature, the input feature may not be specified using patterns or regular expressions.

The second compiler (e.g., “BucketizerHistogramCompiler”) may accept an input feature name and/or index (e.g., “inputIndex”) and a number of buckets (e.g., “numBuckets”) as compilation parameters (e.g., “compilation_configs.compiler_parameters”). The compiler may run over data (e.g., training data) provided as input to the bucketizing transformer and build a histogram from the observed values of the specified input feature. The compiler may then divide the feature into equally sized buckets and assign indexes and names to the buckets.

In a third example, a disjunction transformer may have the following JSON object as an uncompiled “source” configuration:

{

“name”: “disjunction_transfomer”,
“class”:
“com.linkedin.laser.common.transformer.DisjunctionTransformer”,
“parameters”: {

“input”: “some_other_producer”,
“groups”: [

{

“features”: [

“industry:software”,
“industry:information_technology”,
“industry:internet” ],

“name”: “software”,
“index”: 0

},
{

“features”: [ 23, 49, 56, 81 ],
“name”: “finance”,
“index”: 2

}

]

},
“compilation_configs”: [{

“compiler_class”:

“com.linkedin.laser.common.compiler.DisjunctionTransformerCompiler”

“is_compiled”: false,
“compiler_parameters”: {

“groups”: [{

“features”: [ “industry:restaurants”, “industry:hotels” ],
“name”: “hospitality”

}, {

“features”: [ 16, 39, 51, 67 ]

}]

}

}]

}
The disjunction transformer may then be compiled into the following
JSON object:
{

“name”: “disjunction_transfomer”,
“class”:
“com.linkedin.laser.common.transformer.DisjunctionTransformer”,
“parameters”: {

“input”: “some_other_producer”,
“groups”: [

{

“features”: {

“names”: [

“industry:software”,
“industry:information_technology”,
“industry:internet” ],

“indices”: [ 2, 5, 8 ]

},
“name”: “software”,
“index”: 0

},
{

“features”: {
“names”: [

“industry:banking”, “industry:investment”,
“industry:analyst”,
“industry:mutual_fund” ],

“indices”: [ 23, 49, 56, 81 ] },
“name”: “finance”,
“index”: 2

},
{

“features”: {

“names”: [ “industry:restaurants”,
“industry:hotels” ],
“indices”: [ 42, 79 ]

},
“name”: “hospitality”
“index”: 1

},
{

“features”: {

“names”: [

“industry:education”, “industry:tutoring”,
“industry:admissions”,
“industry:publishing”],

“indices”: [ 16, 39, 51, 67 ]

},

“name”: “group_3”,
“index”: 3

}

]

},

}

In the disjunction transformer, both source and compiled formats specify a list of groups, each of which represents a single binary output feature that is a logical disjunction of the binary input features in the group. Each group may have parameters for feature names and/or indexes to include in the group, as specified in “features” in the uncompiled configuration and in “features.names” and “features.indices” in the compiled configuration. The group may also have a “name” parameter that describes the name of the binary output feature. All of the above parameters may be optional. If no “name” is given, one may be synthesized. If neither feature names nor feature indexes are provided as input, the output binary feature will always be zero.

The compiled and pre-written groups in the disjunction transformer may also have an “index” specifying the output index of the output binary feature. If two groups have the same output index, an error may be thrown during compilation and/or initialization. Feature names and indexes may be copied from the uncompiled configuration to the compiled configuration, and an index map for the input feature set to the disjunction transformer may be used to fill in missing feature names for specified feature indexes and feature indexes for specified feature names in the compiled configuration.

In a fourth example, an interaction transformer may have the following JSON object as an uncompiled “source” configuration:

{

“name”: “interaction_transformer”,
“class”: “com.linkedin.laser.commmon.transformer.InteractionTransformer”,
“parameters”: {

“input_left”: “some_other_producer1”,
“input_right”: “some_other_producer2”,
“interactions”: [

{ “left”: 23, “right”: 37, “index”: 0 },
{ “left”: 46, “right”: 51, “index”: 1 },
{ “left”: 66, “right”: 57, “index”: 3 }

]

},
“compilation_configs”: [{

“compiler_class”:

“com.linkedin.laser.common.compiler.InteractionCompiler”,

“is_compiled”: false,
“compiler_parameters”: {

“left_features”: {

“name_regexes”: [ “skill:.*”, “title:.*” ],
“indices”: [ 356, 892, 1471, 2847 ]

},
“right_features”: {

“name_regexes”: [ “format:*”, “page:*” ],
“indices”: [ 39, 52, 78 ]

},
“min_support”: 10000,
“min_support_fraction”: 0.02,
“min_mutual_information”: 0.75,
“max_features”: 1000,
“comparator_class”:

“com.linkedin.laser.common.compiler.SubsetCompiler$SupportComparator”

“interactions”: [

{ “left”: “function:management”, “right”: 95 }

]

},

}]

}
The interaction transformer may then be compiled into the following:
{

“name”: “interaction_transformer”,
“class”: “com.linkedin.laser.commmon.transformer.InteractionTransformer”,
“parameters”: {

“input_left”: “some_other_producer1”,
“input_right”: “some_other_producer2”,
“interactions”: [

{ “left”: 23, “right”: 37, “index”: 0, “name”: “left:23::right:37” },
{ “left”: 46, “right”: 51, “index”: 1, “name”: “left:46::right:51” },
{ “left”: 66, “right”: 57, “index”: 3, “name”: “left:66::right:57” },
{ “left”: 356, “right”: 52, “index”: 2, “name”:

“left:356::format:f17x700” },

{ “left”: 489, “right”: 39, “index”: 4, “name”: “skill:java::right:39” },
{ “left”: 83, “right”: 78, “index”: 5, “name”: “left:83::right:78” },
{ “left”: 234, “right”: 95, “index”: 6, “name”:

“function:management::page_key:200” } ]

}

}

The compiled configuration for the interaction transformer may support an “input_left” parameter specifying the name of a first (e.g., “left”) input feature set and an “input_right” parameter specifying the name of a second (e.g., “right”) input feature set. The compiled configuration also includes an array of “interactions.” Each element in the array may have a “left,” “right,” and “index,” representing the left and right input feature indexes from the corresponding input feature sets and the output index of the output interaction feature, respectively. The element may also have an optional “name” specifying an output feature name for the corresponding interaction. The “left” and “right” input features may be either indexes or names, but may not be patterns because only a single feature may be specified on either side of an interaction.

The source configuration may include compilation parameters (e.g., “compilation_configs.compilation_parameters”) in common with a subset transformer, since the interaction transformer performs an outer product followed by a subset transformation that reduces the number of combined features from the outer product to be included in the interaction transformer. Unlike the subset transformer, the interaction transformer may specify left and right input candidate features (e.g., “input_left,” “input_right”) as names, indexes, and/or patterns.

The compilation parameters may also include an “interactions” parameter that describes candidate features, much like the “interactions” parameter in the pre-written section of the configuration under “parameters.” Because “compilation_configs.compilation_parameters.interactions” does not specify an output index, the compiler may automatically assign output indexes to interactions in the compiled configuration.

Names of interactions (e.g., “parameters.interactions.name”) in the compiled configuration may be automatically generated from the names of the left and right input features participating in the interactions. If the features lack names, ones may be synthesized using the features' corresponding prefixes (e.g., “left:” or “right:”), followed by the features' indexes.

In a fifth example, a summation transformer may have an uncompiled configuration represented by the following JSON object:

{

“name”: “summation_transformer”,
“class”:
“com.linkedin.laser.common.transformer.SummationTransformer”,
“parameters”: {

“input”: “producer”,
“groups”: [

{

“name”: “n_click”,
“index”: 1,
“features”: {

“names”: [

“n_click::−1”,
“n_click::−2”

]

}

}

]

}
“compilation_configs”: [{

“compiler_class”:

“com.linkedin.laser.common.compiler.InteractionCompiler”,

“is_compiled”: false,
“compiler_parameters”: {

“groups”: [

{

“name”: “n_view”,

“features”: {

“range”: {

“name_base”: “n_view::”,
“start”:−2,
“end”:−1

}

}

},

]

}

}]

}
The summation transformer may then be compiled into the following
JSON object:
{

“name”: “summation_transformer”,
“class”:
“com.linkedin.laser.common.transformer.SummationTransformer”,
“parameters”: {

“input”: “producer”,
“groups”: [

{

“name”: “n_view”,
“index”: 0,
“features”: {

“names”: [

“n_view::−1”,
“n_view::−2”

]

}

},
{

“name”: “n_click”,
“index”: 1,
“features”: {

“names”: [

“n_click::−1”,
“n_click::−2”

]

}

}

]

}

}

During compilation of the summation transformer, the “range” parameter in the uncompiled configuration may be expanded into specific features. The “range” expression may be used in lieu of regular expressions and/or patterns, since a numeric range may be difficult to express via regular expression. Features in the range are selected based on criteria such as “name_base,” which specifies a prefix for the feature name, as well as a numeric “start” or “end” to the feature name after the prefix is removed. Feature names that match the prefix and have numbers ranging from “start” to “end” after the prefix may then be included in the compiled configuration. If “start” is missing, negative infinity is used. Similarly, if “end” is missing, positive infinity is used.

Before configurations 236-238 are compiled, a compilation-management apparatus 204 may obtain a dependency graph 214 of feature sources, transformers, and/or an assembler associated with statistical model 202. Compilation-management apparatus 204 may use dependency graph 214 to derive an evaluation order 216 associated with the corresponding configurations for statistical model 202. For example, compilation-management apparatus 204 may generate an evaluation order so that a configuration is not compiled until all of the configuration's dependencies (e.g., other configurations) have been compiled. Conversely, if two configurations do not depend on one another, compilation-management apparatus 204 may indicate that the configurations can be compiled in parallel to expedite the model compilation process. Model compiler 206 may then compile configurations 236-238 according to evaluation order 216. Use of dependency graphs and evaluation orders in compiling configurations for statistical models is described in further detail below with respect to FIG. 3.

After all configurations 236-238 have been converted into compiled forms 222-224 by model compiler 206, compiled forms 222-224 may be used by an execution engine 208 to execute statistical model 202. For example, execution engine 208 may use compiled forms 222-224 to instantiate statistical model 202 and run queries 210 against statistical model 202, either in real-time (e.g., in response to application requests) or offline (e.g., during batch processing of data associated with statistical model 202). Output scores 212 produced by executing statistical model 202 may then be provided in response to queries 210 to facilitate decision-making related to queries 210.

Those skilled in the art will appreciate that the system of FIG. 2 may be implemented in a variety of ways. First, compilation-management apparatus 204, model compiler 206, and execution engine 208 may be provided by a single physical machine, multiple computer systems, one or more virtual machines, a grid, one or more databases, one or more file systems, and/or a cloud computing system. Compilation-management apparatus 204, model compiler 206, and/or execution engine 208 may additionally be implemented together and/or separately by one or more hardware and/or software components and/or layers. For example, a separate implementation and/or instance of model compiler 206 may be provided for each configuration type (e.g., feature source, assembler, subset transformer, disjunction transformer, bucketizer transformer, interaction transformer, summation transformer) and/or instance in statistical model 202. On the other hand, the same model compiler 206 and/or instance of model compiler 206 may be used to compile configurations for all feature sources, transformers, and/or assemblers associated with statistical model 202.

Second, a number of statistical models, techniques, and/or data formats may be supported by and/or used with configurations 236-238, compilation-management apparatus 204, model compiler 206, and/or execution engine 208. For example, configurations 236-238 and compiled forms 222-224 may be used to perform feature selection for support vector machines (SVMs), artificial neural networks (ANNs), naïve Bayes classifiers, decision trees, regression models, and/or other type of predictive or descriptive models. Similarly, configurations 236-238 and/or compiled forms 222-224 may be created, stored, and/or transmitted in a number of formats, including database records, property lists, Extensible Markup language (XML) documents, JSON objects, and/or other types of structured data.

FIG. 3 shows an exemplary dependency graph and data flow associated with feature selection in a statistical model in accordance with the disclosed embodiments. As shown in FIG. 3, the dependency graph includes three feature sources 308-312, three transformers 314-318, and an assembler 320. Other embodiments may exhibit different configurations.

In the exemplary embodiment of FIG. 3, each feature source 308-312 may obtain raw data 302-306 from one or more external sources such as databases, data warehouses, cloud storage, and/or other data-storage mechanisms. For example, feature sources 308-312 may obtain data related to users, organizations, advertisements, content, applications, websites, and/or events. Each feature source 308-312 may process the corresponding raw data 302-306 into a feature vector 334-338. For example, a feature source may create a feature vector containing user data, with different elements of the vector containing different data elements (e.g., name, age, location, contact information, demographic information, etc.) related to one or more users. In other words, feature sources 308 may provide data 302-306 in a standardized, reusable format that can be subsequently used by other components (e.g., transformers 314-318, assembler 320) associated with the statistical model.

Next, feature vectors 334-338 may be provided as input to transformers 314-316, which generate additional feature vectors 340-342 from the input. Feature vectors 340-342 outputted by transformers 314-316 may then be provided as input to transformer 318, and transformer 318 may generate another feature vector 344 from the input feature vectors 340-342.

As described above, transformers 314-318 may transform data from input feature vectors 334-342 in a number of ways. For example, each transformer 314-318 may be a subset transformer that generates a feature subset as a subset of a set of input features from an input feature vector and/or a bucketizing transformer that transforms a numeric input feature into a set of binary numeric features. Transformers 314-318 may also include a disjunction transformer that performs a logical disjunction of one or more sets of binary input features and/or an interaction transformer that calculates an outer product of a first subset of input features and a second subset of input features. Finally, transformers 314-318 may include a summation transformer that sums a set of values for an input feature over a range.

Output feature vectors 338-344 from feature source 312 and transformers 314-318 may be provided as input to assembler 320, which packages feature vectors 338-344 into an assembled feature vector 346 that can be used to train and/or execute the statistical model. Within assembled feature vector 346, blocks of elements may correspond to data from different feature vectors 338-344 provided as input to assembler 320.

In addition, feature sources 308-312 and transformers 314-318 may each include an index map 322-332 for the corresponding output feature vector 334-344. Index maps 322-332 may include bidirectional string-to-integer maps of feature names to feature indexes in feature vectors 334-344. For example, an index map for a feature vector with 10 elements may have 10 mappings between numeric indexes 0-9 of the feature vector and 10 feature names of features associated with the indexes.

In turn, index maps 322-332 may be used by a model compiler (e.g., model compiler 206 of FIG. 2) to fill in missing feature names and/or indexes during compilation of configurations for components (e.g., transformers 314-318, assembler 320) that accept feature vectors 334-344 as input. For example, a configuration for transformer 316 may include compilation parameters that specify indexes for input features from feature vector 336 and feature names and/or feature name patterns (e.g., regular expressions) for input features from feature vector 338. During compilation of the configuration, the model compiler may use index map 324 to fill in the feature names of input features matching the specified indexes from feature vector 336 and index map 326 to fill in the feature indexes of the input features matching the feature names and/or patterns from feature vector 338. Input feature names in the compiled form of the configuration may thus map one-to-one to input feature indexes in the compiled form.

Moreover, the use of index maps 322-332 by the compiler may provide creators of the configurations additional flexibility in describing features to be used and/or transformed by components associated with the configurations. For example, a user may use concise regular expressions and/or descriptive feature names to identify input features for inclusion in a transformer instead of manually generating a comprehensive list of numeric indexes for all features matching the regular expressions and/or feature names. The model compiler may use an index map for the input feature vector to the transformer to compile the comprehensive list of features and/or feature indexes matching the regular expressions and/or feature names for the user and include the list in the compiled form of the transformer's configuration. Consequently, the model compiler may reduce overhead and/or error associated with manually matching feature indexes to the regular expression and/or feature names and adding the feature indexes to the transformer's configuration.

Because various components produce output (e.g., feature vectors 334-344) that is used as input to other components, feature sources 308-312, transformers 314-318, and assembler 320 may form a dependency graph associated with feature selection in the statistical model. Within the dependency graph, feature source 308 may be a dependency of transformer 314, feature sources 310-312 may be dependencies of transformer 316, transformers 314-316 may be dependencies of transformer 318, and feature source 312 and transformers 314-316 may be dependencies of assembler 320. Such dependencies may be declared in the configurations of the components as input sources of the components and/or explicit dependencies of the components.

To maintain consistency in features used during training and execution of the statistical model, a compilation-management apparatus (e.g., compilation-management apparatus 204 of FIG. 2) may use the dependency graph to derive an evaluation order associated with feature sources 308-312, transformers 314-318, and assembler 320. For example, the compilation-management apparatus may generate an evaluation order that specifies the compilation of feature sources 308-312 before transformers 314-316, the compilation of transformers 314-316 before transformer 318, and the compilation of transformer 318 before the compilation of assembler 320.

Prior to initiating compilation of the components' configurations, the compilation-management apparatus may also validate the dependency graph to ensure that the dependency graph does not contain circular dependencies among the components. If a circular dependency is detected, the compilation-management apparatus may terminate use of the dependency graph in compiling the configurations, since no valid evaluation order exists for the dependency graph. Instead, the compilation-management apparatus may require that the components be compiled using a different dependency graph that does not contain circular dependencies.

To analyze the dependency graph for circular dependencies, the compilation-management apparatus and/or instantiations of the components' configurations may record a traversal of the dependency graph beginning at one or more root nodes of the dependency graph. A circular dependency may be detected if the traversal reaches a previously traversed node in the dependency graph. For example, detection of circular dependencies may be performed in a distributed manner by generating a list of component identifiers and passing the list from instantiated configurations of the root nodes to instantiated configurations of nodes with dependencies on the root nodes and/or other nodes in the dependency graph. Once an instantiated configuration receives the list, the configuration adds its component identifier to the list. A cycle may thus be detected when a configuration sees its own component identifier in the list.

After the dependency graph is validated and the evaluation order generated, the model compiler may compile the configurations for the components according to the evaluation order. For example, the model compiler may compile the configurations using data-intensive jobs on a distributed data-processing mechanism such as Apache Hadoop. Because the jobs may perform complex operations on large data sets, each configuration may take minutes to hours to compile.

To expedite compilation of the configurations, the model compiler may use the evaluation order to compile, in parallel, two or more of the configurations without dependencies on one another. For example, the model compiler may initiate compilation of feature sources 308-312 in parallel. When feature source 308 has been compiled, the model compiler may initiate compilation of transformer 314, and when feature sources 310-312 have compiled, the model compiler may initiate compilation of transformer 316 independently of the compilation of transformer 314. After both transformers 314-316 have compiled, the model compiler may initiate compilation of transformer 318. Finally, after transformer 318 has compiled, the model compiler may initiate compilation of assembler 320.

To further expedite compilation of the configurations, the model compiler may save the compiled form of each configuration after completing compilation of the configuration. Thus, if the model compiler detects an error in a subsequent configuration in the evaluation order, the model compiler can terminate compilation of the subsequent configuration without affecting previously compiled configurations. After the model compiler receives a correction to the error, the model compiler may resume compilation of the subsequent configuration without recompiling the previously compiled configurations, since the previously compiled configurations have been saved.

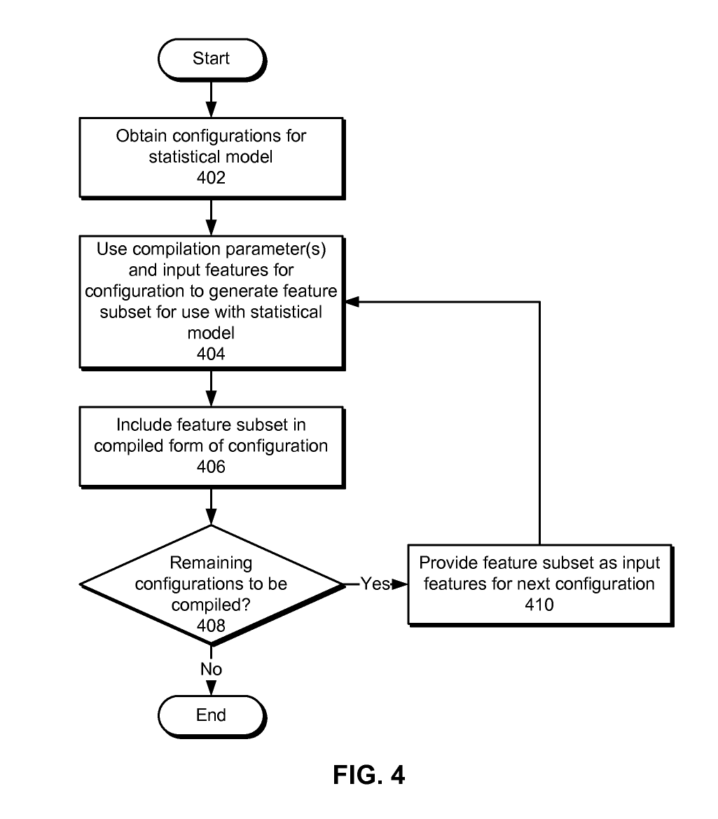

FIG. 4 shows a flowchart illustrating the processing of data in accordance with the disclosed embodiments. More specifically, FIG. 4 shows a flowchart of model compilation for feature selection in a statistical model in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of configurations for a statistical model is obtained (operation 402). Each configuration may include a high-level description of features to be created, transformed, and/or used in a feature source, transformer, assembler, and/or other component associated with feature selection in the statistical model. The high-level description may be provided using one or more compilation parameters in the configuration.

For example, the configuration may be for a transformer, such as a subset transformer, bucketizing transformer, disjunction transformer, interaction transformer, and/or summation transformer. The subset transformer may perform feature selection by generating a feature subset as a subset of a set of input features to the subset transformer. Compilation parameters for the subset transformer may include a minimum support, a minimum support fraction, a minimum mutual information, a maximum number of features, and/or a comparator associated with sorting the first set of input features. The bucketizing transformer may transform a numeric input feature into a set of binary numeric features and include compilation parameters such as an input feature and a number of buckets. The disjunction transformer may perform a logical disjunction of one or more sets of binary input features and include compilation parameters that specify the set(s) of binary features. The interaction transformer may calculate an outer product of a first subset of input features and a second subset of input features. Compilation parameters for the interaction transformer may include the first and second subsets of features, a minimum support fraction, a minimum mutual information, a maximum number of features, and/or a comparator associated with sorting the input features. The summation transformer may sum a set of values for an input feature over a range and include compilation parameters for the input feature and the range.

Next, the compilation parameter(s) and set of input features for the configuration are used to generate a feature subset for use with the statistical model (operation 404). For example, the compilation parameter(s) may be used to identify specific input features for inclusion in the component and/or transformation by the component. In addition, an index map associated with the input features may be used to match a feature name pattern from the compilation parameter(s) to one or more feature indexes in the input features. The matching feature indexes may then be included in the feature subset.

After the feature subset is generated, the feature subset is included in a compiled form of the configuration (operation 406). For example, the compiled form may include a comprehensive list of feature indexes and/or feature names of features to be used, transformed, and/or outputted by the component. The compiled form may thus contain detailed information that is used to train and/or execute the statistical model.

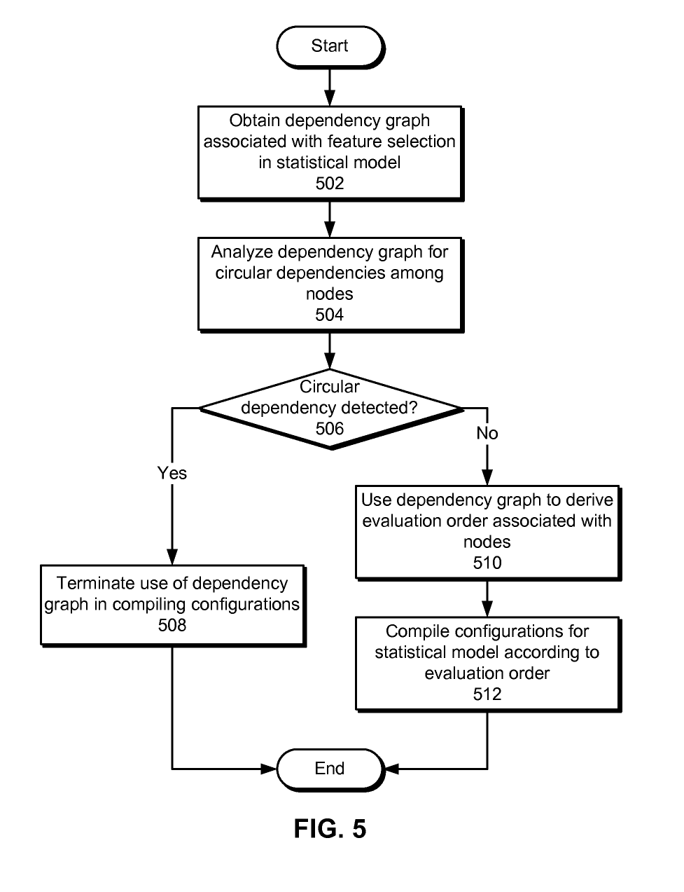

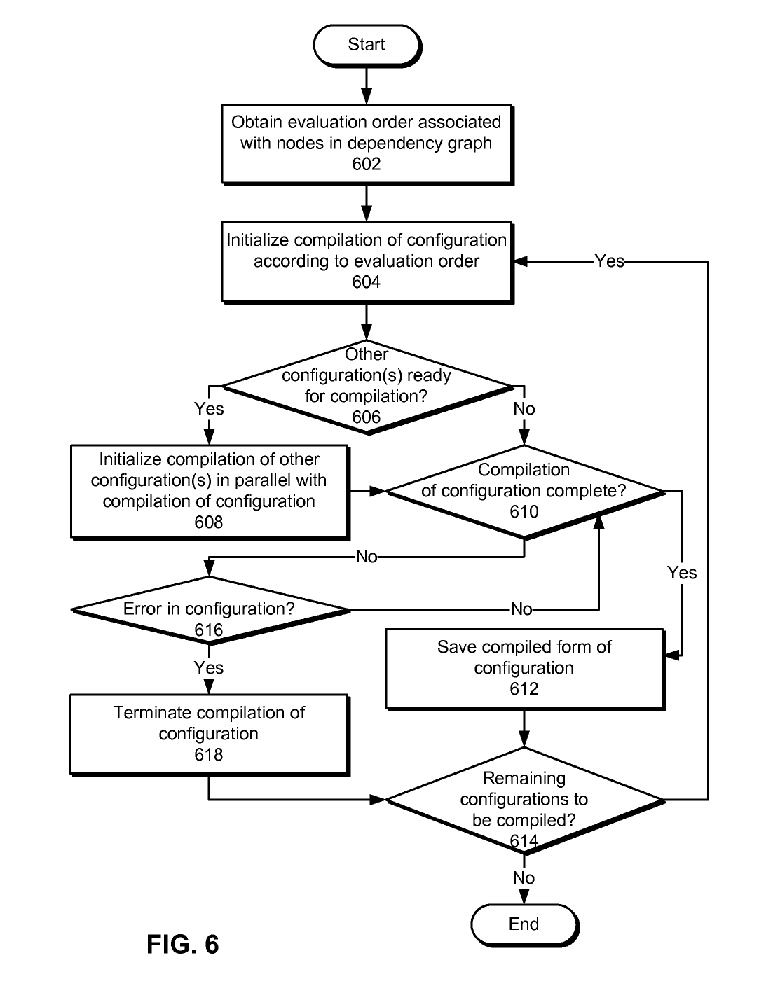

Other configurations may remain to be compiled (operation 408) after compilation of the configuration is complete. For example, configurations that depend on the configuration may only be compiled after the configuration has been compiled, as described in further detail below with respect to FIGS. 5-6. If other configurations require compilation, the configuration's feature subset is provided as a set of input features for the next configuration (operation 410) that depends directly on the configuration. The next configuration may then be compiled by generating a feature subset for the next configuration and including the feature subset in the compiled form of the next configuration (operations 404-406). Remaining, uncompiled configurations (operation 408) may thus be compiled until all configurations for the statistical model have been compiled and/or an error is found in one of the configurations.

FIG. 5 shows a flowchart illustrating the processing of data in accordance with the disclosed embodiments. In particular, FIG. 5 shows a flowchart of dependency management during model compilation of a statistical model in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a dependency graph associated with feature selection in the statistical model is obtained (operation 502). Nodes in the dependency graph may include one or more feature sources, transformers, assemblers, and/or other components associated with the statistical model. The dependency graph may be validated prior to compiling configurations for the components. To validate the dependency graph, the dependency graph is analyzed for circular dependencies among the nodes (operation 504). For example, a traversal of the dependency graph beginning at one or more roots of the dependency graph may be recorded, and a circular dependency may be detected when the recorded traversal reaches a previously traversed node in the dependency graph.

Compilation of the configurations may be managed based on the detected presence or absence of circular dependencies (operation 506) in the dependency graph. If no circular dependencies are detected, the dependency graph is used to derive an evaluation order associated with the nodes (operation 510), and the configurations are compiled according to the evaluation order (operation 512), as discussed in further detail below with respect to FIG. 6. If a circular dependency is detected, use of the dependency graph in compiling the configurations is terminated (operation 508) because no valid evaluation order exists for the dependency graph. Instead, compilation of the configurations may resume with a different dependency graph that does not contain circular dependencies.

FIG. 6 shows a flowchart illustrating the process of compiling a set of configurations for a statistical model according to an evaluation order in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

As mentioned above, an evaluation order associated with nodes in a dependency graph is obtained (operation 602). Next, compilation of a configuration from the set of configurations is initialized according to the evaluation order (operation 604). For example, compilation of a root node of the dependency graph may be initialized because the root node does not depend on other nodes of the dependency graph.

One or more other configurations may also be ready for compilation (operation 606). For example, the other configuration(s) may be ready for compilation if the other configuration(s) also do not have unresolved dependencies on other nodes of the dependency graph. If other configurations are ready for compilation, compilation of the other configurations is initialized in parallel with compilation of the configuration (operation 608) to expedite compilation of the configurations. If no other configurations are ready to be compiled, compilation of just the configuration is carried out.

Compilation of each configuration may be complete (operation 610) after a feature subset for the configuration has been selected and included in the configuration's compiled form. For example, a configuration may be compiled after a data-intensive job that selects features for inclusion in the configuration has completed and a compiled form of the configuration containing the selected features is created. Once the configuration is compiled, the compiled form of the configuration is saved (operation 612), and remaining configurations to be compiled (operation 614) are compiled according to the evaluation order (operations 604-608). For example, once compilation of a feature source is complete, compilation of two transformers that depend only on the feature source may be initiated in parallel.

On the other hand, a configuration may contain an error (operation 616) that prevents successful compilation of the configuration. For example, the configuration may lack required configuration parameters and/or have values for configuration parameters that violate compilation rules for the configuration. If no error is found, compilation of the configuration may continue.

If an error is found in the configuration, compilation of the configuration is terminated (operation 618). Remaining configurations that need to be compiled (operation 614) and do not depend on the configuration may continue to be compiled (operations 606-610), and compiled forms of the remaining configurations may be saved (operations 612) if the compilation of the remaining configurations is successful. Compilation of the configuration may then resume after a correction to the error is received. Because previously compiled configurations are saved, compilation of the configuration may be performed without recompiling the previously compiled configurations, thus further streamlining the model compilation process.

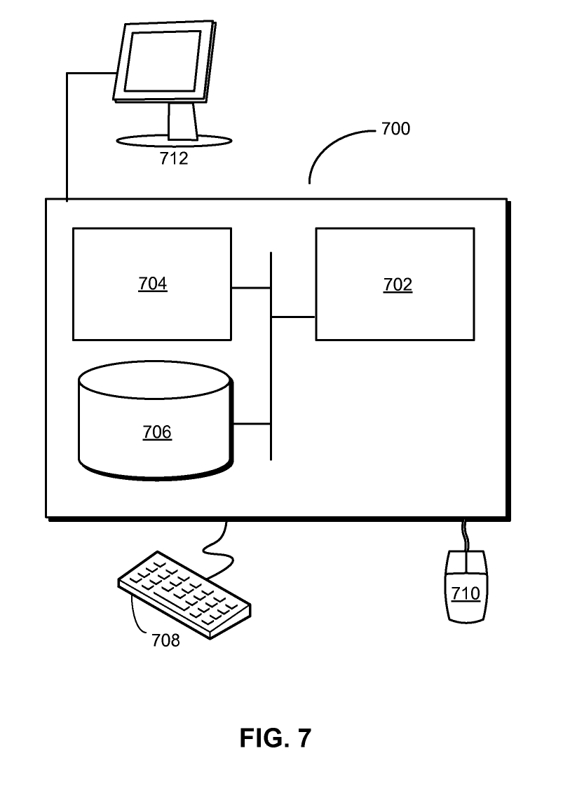

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for processing data. The system may include a model compiler that obtains a first configuration for a statistical model. The first configuration may include one or more compilation parameters associated with feature selection in the statistical model. Next, the model compiler may use the compilation parameter(s) and a first set of input features for the first configuration to generate a first feature subset for use with the statistical model and include the first feature subset in a first compiled form of the first configuration. The system may also include an execution engine that uses the first compiled form to execute the statistical model.

The model compiler may also use the first feature subset as a second set of input features for a second configuration for the statistical model. The model compiler may further use one or more additional compilation parameters from the second configuration and the second set of input features to generate a second feature subset for use with the statistical model and include the second feature subset in a second compiled form of the second configuration. The execution engine may then use the second compiled form to execute the statistical model.

The system may further include a compilation-management apparatus that obtains a dependency graph associated with feature selection in the statistical model. Nodes in the dependency graph may include one or more feature sources, one or more transformers, and an assembler. The compilation-management apparatus may validate the dependency graph and/or use the dependency graph to derive an evaluation order associated with the nodes. The model compiler may then compile the configurations for the statistical model according to the evaluation order.

In addition, one or more components of computer system 700 may be remotely located and connected to the other components over a network. Portions of the present embodiments (e.g., model compiler, execution engine, compilation-management apparatus, etc.) may also be located on different nodes of a distributed system that implements the embodiments. For example, the present embodiments may be implemented using a cloud computing system that performs feature selection, model training, and/or model execution for analytics using data from a set of remote sources.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for processing data, comprising:
obtaining a dependency graph associated with feature selection in a statistical model, wherein nodes in the dependency graph comprise one or more feature sources, one or more transformers, and an assembler;
using the dependency graph to derive an evaluation order associated with the nodes; and
compiling a set of configurations for the statistical model according to the evaluation order.

2. The computer-implemented method of claim 1, further comprising:
validating the dependency graph prior to compiling the set of configurations.

3. The computer-implemented method of claim 2, wherein validating the dependency graph comprises:
analyzing the dependency graph for circular dependencies among the nodes; and
upon detecting a circular dependency in the dependency graph, terminating use of the dependency graph in compiling the set of configurations.

4. The computer-implemented method of claim 3, wherein analyzing the dependency graph for circular dependencies among the nodes comprises:
recording a traversal of the dependency graph beginning at one or more root nodes of the dependency graph; and
detecting the circular dependency in the dependency graph when the recorded traversal reaches a previously traversed node in the dependency graph.

5. The computer-implemented method of claim 1, wherein compiling the set of configurations for the statistical model according to the evaluation order comprises:
using the evaluation order to compile, in parallel, two or more of the configurations without dependencies on one another.

6. The computer-implemented method of claim 1, wherein compiling the set of configurations for the statistical model according to the evaluation order comprises:
upon completing compilation of a first configuration from the set of configurations:
saving a compiled form of the first configuration; and
initializing compilation of a second configuration from the set of configurations following the first configuration in the evaluation order.

7. The computer-implemented method of claim 6, wherein compiling the set of configurations for the statistical model according to the evaluation order comprises:
upon detecting an error in the second configuration, terminating compilation of the second configuration; and
upon receiving a correction to the error, resuming compilation of the second configuration without recompiling the first configuration.

8. The computer-implemented method of claim 1, wherein the dependency graph comprises a first dependency from the one or more sources to the one or more transformers and a second dependency from the one or more transformers to the assembler.

9. The computer-implemented method of claim 8, wherein the dependency graph further comprises a third dependency between a first transformer and a second transformer in the one or more transformers.

10. A system for processing data, comprising:
a compilation-management apparatus configured to:
obtain a dependency graph associated with feature selection in a statistical model, wherein nodes in the dependency graph comprise one or more feature sources, one or more transformers, and an assembler; and
use the dependency graph to derive an evaluation order associated with the nodes; and
a model compiler configured to compile a set of configurations for the statistical model according to the evaluation order.

11. The system of claim 10, wherein the compilation-management apparatus is further configured to:
validate the dependency graph prior to compiling the set of configurations.

12. The system of claim 11, wherein validating the dependency graph comprises:
analyzing the dependency graph for circular dependencies among the nodes; and
upon detecting a circular dependency in the dependency graph, terminating use of the dependency graph in compiling the set of configurations.

13. The system of claim 10, wherein compiling the set of configurations for the statistical model according to the evaluation order comprises:
using the evaluation order to compile, in parallel, two or more of the configurations without dependencies on one another.

14. The system of claim 10, wherein compiling the set of configurations for the statistical model according to the evaluation order comprises:
upon completing compilation of a first configuration from the set of configurations:
saving a compiled form of the first configuration; and
initializing compilation of a second configuration from the set of configurations following the first configuration in the evaluation order.

15. The system of claim 10, wherein the one or more transformers comprise at least one of:
a subset transformer that generates a subset of a set of input features;
a bucketizing transformer that transforms a numeric input feature into a set of binary numeric features;
a disjunction transformer that performs a logical disjunction of one or more sets of binary input features;
an interaction transformer that calculates an outer product of a first set of input features and a second set of input features; and
a summation transformer that sums a set of values for an input feature over a range.

16. A non-transitory computer-readable storage medium storing instructions that when executed by a computer cause the computer to perform a method for processing data, the method comprising:
obtaining a dependency graph associated with feature selection in a statistical model, wherein nodes in the dependency graph comprise one or more feature sources, one or more transformers, and an assembler;
using the dependency graph to derive an evaluation order associated with the nodes; and
compiling a set of configurations for the statistical model according to the evaluation order.

17. The non-transitory computer-readable storage medium of claim 16, the method further comprising:
validating the dependency graph prior to compiling the set of configurations.

18. The non-transitory computer-readable storage medium of claim 17, wherein validating the dependency graph comprises:
analyzing the dependency graph for circular dependencies among the nodes; and
upon detecting a circular dependency in the dependency graph, terminating use of the dependency graph in compiling the set of configurations.

19. The non-transitory computer-readable storage medium of claim 16, wherein compiling the set of configurations for the statistical model according to the evaluation order comprises:
using the evaluation order to compile, in parallel, two or more of the configurations without dependencies on one another.

20. The non-transitory computer-readable storage medium of claim 16, wherein compiling the set of configurations for the statistical model according to the evaluation order comprises:
upon completing compilation of a first configuration from the set of configurations:
saving a compiled form of the first configuration; and
initializing compilation of a second configuration from the set of configurations following the first configuration in the evaluation order.
